(19) United States
(12) Patent Application Publication
(10) Pub. No.: US 2012/0209500 A1
(43) Pub. Date: Aug. 16, 2012

(54) Systems And Methods For Detecting That An Engine Is Being Operated In a Confined Space

(75) Inventors: Tim A. Haskew, Northport, AL (US); Paul Puzinauskas, Tuscaloosa, AL (US); Jennifer B. Smelser, Pearland, TX (US)

(73) Assignee: The Board of Trustees of the University of Alabama, Tuscaloosa, AL (US)

(21) Appl. No.: 13/370,977

(22) Filed: Feb. 10, 2012

Related U.S. Application Data
(60) Provisional application No. 61/441,361, filed on Feb. 10, 2011.

(51) Int. Cl. F02D 41/22; G01M 15/04

(52) U.S. Cl. 701/112; 701/99

(57) ABSTRACT

In one embodiment, systems and methods for detecting when an engine is being operated in a confined space relate to monitor changes in engine operating parameters related to fuel injection pulse widths and determining whether or not the engine is being operated in a confined space based upon the monitored changes.

### CROSS-REFERENCE TO RELATED APPLICATION

This application claims priority to co-pending U.S. provisional application entitled, “Detecting An Operation Of Aⁿ Engine In A Confined Space And Reducing Carbon Monoxide Emissions,” having Ser. No. 61/441,361, filed Feb. 10, 2011, which is entirely incorporated herein by reference.

### BACKGROUND

Engines produce carbon monoxide gas (CO), which is odorless, colorless, and toxic. Each year, 70-90 deaths occur due to CO poisoning resulting from portable engines being operated in confined spaces. Accordingly, it would be desirable to be able to detect when an engine is being operated in a confined space so that the engine can be automatically shut off before someone is harmed. Although CO sensors or extremely sensitive oxygen O₂ sensors may be used at the intake to measure changes in CO or minute changes in O₂, these options are costly. Also, O₂ sensors can be susceptible to error due to the humidity in the air. Plus, CO sensors often have short lifespans and corrode easily. Therefore, CO sensors are prone to failure, which is less than ideal for a product that is detecting whether the operating conditions are safe.

### BRIEF DESCRIPTION OF THE DRAWINGS

The present disclosure may be better understood with reference to the following figures. Matching reference numerals designate corresponding parts throughout the figures, which are not necessarily drawn to scale.

FIG. 1 is a block diagram of an embodiment of an engine management system configured to detecting operation of an engine in a confined space.

FIG. 2 includes multiple graphs that compare various engine operation parameter trends for an engine operated in a confined space versus an engine operated in a non-confined space.

FIG. 3 is a flow chart illustrating a first embodiment of a method for detecting that the engine is being operated in a confined space.

FIGS. 4A-4D are flow charts illustrating a second embodiment of a method for detecting that the engine is being operated in a confined space.

FIGS. 5A-5D are flow charts illustrating a third embodiment of a method for detecting that the engine is being operated in a confined space.

FIG. 6 is a flow chart illustrating a fourth embodiment of a method for detecting that the engine is being operated in a confined space.

FIGS. 7A and 7B are flow charts illustrating a fifth embodiment of a method for detecting that the engine is being operated in a confined space.

### DETAILED DESCRIPTION

The present disclosure describes various embodiments of systems and methods for detecting that an engine is being operated in a confined space. An engine may be controlled by an engine management system (EMS) that receives various inputs such as exhaust oxygen levels, intake air temperature, engine rotational speed, and manifold pressure, among others. The engine management system uses these inputs to generate outputs to control parameters such as fuel injection and spark ignition. The fuel injection and spark ignition are controlled by signals delivered for a specific duration and at a specific time in the engine cycle as determined by the EMS control algorithm to optimize engine performance. In particular, the amount of fuel delivered to the engine is controlled by the fuel-injection pulse width, which is the time duration that the EMS commands the fuel-injector to remain open and allow fuel to flow. The actual amount of fuel delivered for a given pulse-width duration depends on the fuel-delivery pressure and the characteristics of each particular fuel injector.

The engine management system calculates the fuel injection pulse width which will deliver the optimum fuel-air ratio for the current operating condition as programmed in the EMS during an engine calibration process. This calculation may be based on several assumptions regarding engine state of wear and atmospheric conditions, e.g., that the air consists of a certain mixture of gases with a particular percentage of oxygen. However, when the engine is operated in a confined space, the air mixture changes as exhaust gases, which contain little or no oxygen, displace fresh air. This change in air mixture causes the fuel-air ratio resulting from the calculated pulse width, which was based upon the assumed air mixture ratio, to increase above the optimum value due to the depletion of oxygen in the confined environment. Various embodiments of systems and methods utilize this distorted air-fuel ratio value to detect that the engine is operating in a confined space and, in some embodiments, pause or disable the engine for safety purposes.

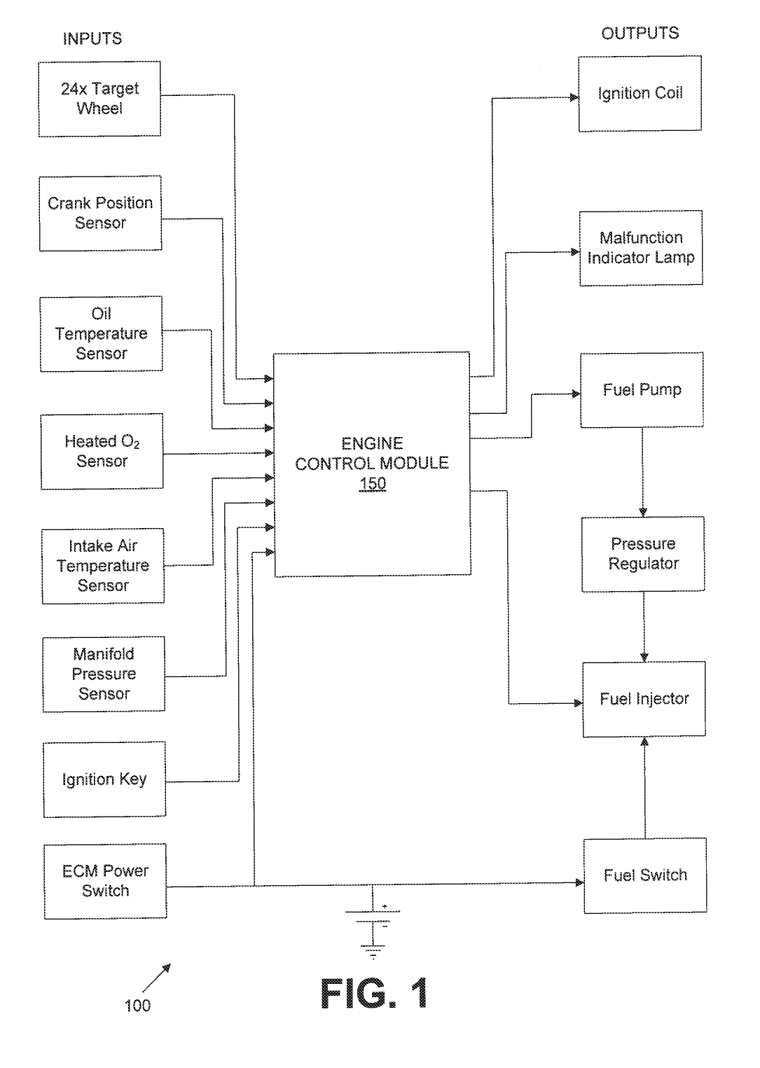

FIG. 1 illustrates a nonlimiting embodiment of an engine management system 100 for detecting operation of an engine in a confined space. The engine management system 100 includes an engine control module 150 and a variety of inputs and outputs. The inputs include signals from a 24× target wheel, a crank position sensor, an oil temperature sensor, a heated O₂ sensor, an intake air temperature sensor, a manifold pressure sensor, an ignition key, and an engine control module power switch. The outputs include signals to an ignition coil, a malfunction indicator lamp, a fuel pump, and a fuel injector. A pressure regulator receives a signal from the fuel pump, and the pressure regulator sends a signal to the fuel injector. The signal sent from the crank position sensor corresponds to the speed of the engine (e.g., rotations per minute (RPM)).

Smaller air-cooled engines are typically operated using a mixture of fuel and air that is referred to as “rich” because the mixture includes more fuel than a stoichiometric mixture. When a stoichiometric mixture is used and complete combustion occurs in the engine, almost all of the carbon in the fuel is converted to carbon dioxide CO₂ and almost all of the hydrogen in the air is converted to water, H₂O. When an engine is operated using a rich mixture of fuel and air, there may not be enough oxygen to oxidize the carbon and the hydrogen, and thus large amounts of carbon monoxide (CO) can be produced. Many gasoline engines are often operated using a rich mixture at higher loads because the energy required to evaporate the additional fuel provides a cooling effect. Many smaller air cooled engines use this additional cooling over much of their operating range.

In some embodiments, a stoichiometric mixture can be used to reduce CO emissions instead of a rich mixture, and the engine can be controlled by the engine management system 100 to deliver an appropriate amount of fuel for the stoichiometric mixture by the fuel injector under various operating conditions. Specifically, the engine management system 100 calculates a fuel injection pulse width that is the amount of time that the fuel injector injects fuel into the engine to achieve a stoichiometric mixture.

The engine management system 100 may be operated with or without feedback regarding the fuel-to-air ratio, which is related to previous fuel injection pulse width values. The calculations for determining a fuel injection pulse width without feedback (referred to as “open loop”) are explained in the following paragraphs. To begin, the fuel required for an engine cycle can be calculated by Eqn. (1) below:

$${m}_{fuel} = {m}_{air} \frac{F}{A} {\vert}_{desired} \qquad ( 1 )$$

where m_{fuel} is a mass of fuel consumed in an engine cycle, mₐᵢᵣ is a mass of air sucked in by the engine during the engine cycle, and

$$\frac{F}{A} {\vert}_{desired}$$

is a desired fuel-to-air ratio which, depending on the operating condition, may correspond to a stoichiometric mixture. The value mₐᵢᵣ can be calculated based upon volumetric efficiency ηᵥₒₗ, as shown in Eqn. (2),

$${m}_{air} = {ρ}_{air} {V}_{disp} {η}_{vol} \frac{F}{A} {\vert}_{desired} \qquad ( 2 )$$

where ρₐᵢᵣ is an air density and V_{disp} is a displacement volume. While mₐᵢᵣ is determined in Eqn. (2) using the speed-density strategy, mₐᵢᵣ can alternatively be measured directly using a mass air flow strategy.

The ρₐᵢᵣ can be calculated by dividing the manifold pressure Pₘₐₙ by the ideal gas constant, R, multiplied by an intake air temperature, T, as shown in Eqn. (3) below.

$${ρ}_{air} = \frac{{P}_{man}}{RT} \qquad ( 3 )$$

Further, m_{fuel}, corresponds to the fuel injection pulse width PWᵢₙⱼ divided by a constant K, which depends on fuel pressure and the fuel-injector characteristics, as shown below in Eqn. (4).

$${m}_{fuel} = \frac{1}{K} {PW}_{inj , ol} \qquad ( 4 )$$

Accordingly, the fuel injection pulse width can be calculated by substituting

$$\frac{{P}_{man}}{RT}$$

for ρₐᵢᵣ in Eqn. (2) above, as illustrated in Eqns. (5) and (6), where K̅ is a constant that combines K, R, and V_{disp}.

$$\begin{matrix}{PW}_{inj , ol} = K \frac{{P}_{man}}{RT} {V}_{disp} {η}_{vol} \frac{F}{A} {\vert}_{desired} \\ = \overline{K} \frac{{P}_{man}}{T} {η}_{vol} \frac{F}{A} {\vert}_{desired}\end{matrix} \qquad \begin{matrix}\begin{matrix}( 5 ) \\ \end{matrix} \\ ( 6 )\end{matrix}$$

The ηᵥₒₗ can be determined from a look-up table based on a manifold pressure Pₘₐₙ (or MAP), which is a load indicating parameter, and an engine speed (RPM). Table 1 below is an example of a look-up table corresponding to the engine used to generate the experimental results provided in the present disclosure. However, another look-up table corresponding to another engine may be used. The independent variables for such tables will typically be a load indicating parameter and an engine speed parameter. In addition to MAP, examples of other load indicating parameters include throttle position and air mass flow. Such look-up tables are used for parameters other than volumetric efficiency.

As discussed above, in some embodiments, the engine management system 100 may be operated using feedback regarding the fuel-to-air ratio, which is related to previous fuel injection pulse width values. The calculations for determining fuel injection pulse width using feedback (referred to a “closed loop”) is described in Eqn. (7).

PW_{inj,cl}=PW_{inj,ol}+PW_{corr,st} (7)

TABLE 1
Look-up Table for Volumetric Efficiency ηᵥₒₗ (%)

| | | Engine Speed (RPM) | | | | | | | | | | |
|---|---|---|---|---|---|---|---|---|---|---|---|---|
| | | 400 | 800 | 1200 | 1600 | 2000 | 2400 | 2800 | 3200 | 3600 | 4000 | 4400 |
| Manifold | 20 | 45 | 45 | 44 | 43 | 42 | 41 | 39 | 37 | 35 | 34 | 31 |
| Pressure | 30 | 51 | 52 | 51 | 50 | 49 | 48 | 47 | 45 | 44 | 42 | 40 |
| (kPa) | 40 | 59 | 61 | 59 | 58 | 58 | 57 | 56 | 54 | 53 | 50 | 48 |
| | 50 | 68 | 70 | 68 | 67 | 67 | 66 | 65 | 64 | 62 | 59 | 56 |
| | 60 | 78 | 79 | 78 | 77 | 76 | 76 | 75 | 73 | 72 | 68 | 65 |
| | 70 | 90 | 90 | 88 | 86 | 86 | 85 | 85 | 83 | 81 | 76 | 72 |
| | 80 | 100 | 100 | 98 | 97 | 98 | 99 | 101 | 98 | 96 | 87 | 80 |
| | 90 | 105 | 105 | 102 | 101 | 103 | 103 | 104 | 102 | 100 | 95 | 90 |

As can be seen above, Eqn. (7) is based at least in part on the fuel injection pulse width calculation without feedback described in Eqns. (5) or (6) above. Eqn. (7) includes a fuel injection pulse width correction term PW_{corr,st} that is added to PW_{inj,ol} calculate PW_{inj,cl}. In some embodiments, a long term correction factor, LTCF, may be used in the calculation for determining a fuel injection pulse width as well, as illustrated in Eqn. (8),

PW_{inj,cl}=LTCF*(PW_{inj,ol}+PW_{corr,st}). (8)

The LTCF is useful for adjusting the fuel injection pulse width to correct for system degradation over time as opposed to PW_{corr,st}, which corrects on the order of several engine cycles. The chemical formula in Eqn. (9) below describes the relationship between fuel (octane used for purposes of example) and air for a stoichiometric mixture that is combusted:

C₈H₁₈+12.5*(O₂+3.77N₂)→8CO₂+9H₂O+47.125N₂ (9)

Note that calculations for fuel injection pulse width with and without feedback above are based on the assumption that the engine is to be operated in a non-confined space and that the mixture of gases in the air is typical of open spaces. The air in the non-confined space is represented by (O₂+3.77N₂) in Eqn. (9), which indicates that O₂ is about 20% of the air and what remains are inert gases, which are represented by the nitrogen, N.

However, after the engine operates in a confined space, the ratio of O₂ to inert gases in the air is such that there is much less O₂ than in the air in a non-confined space. Incomplete combustion results, and the engine speed drops. Correspondingly, the throttle opens and the MAP increases. Thus, the fuel pulse width will actually increase.

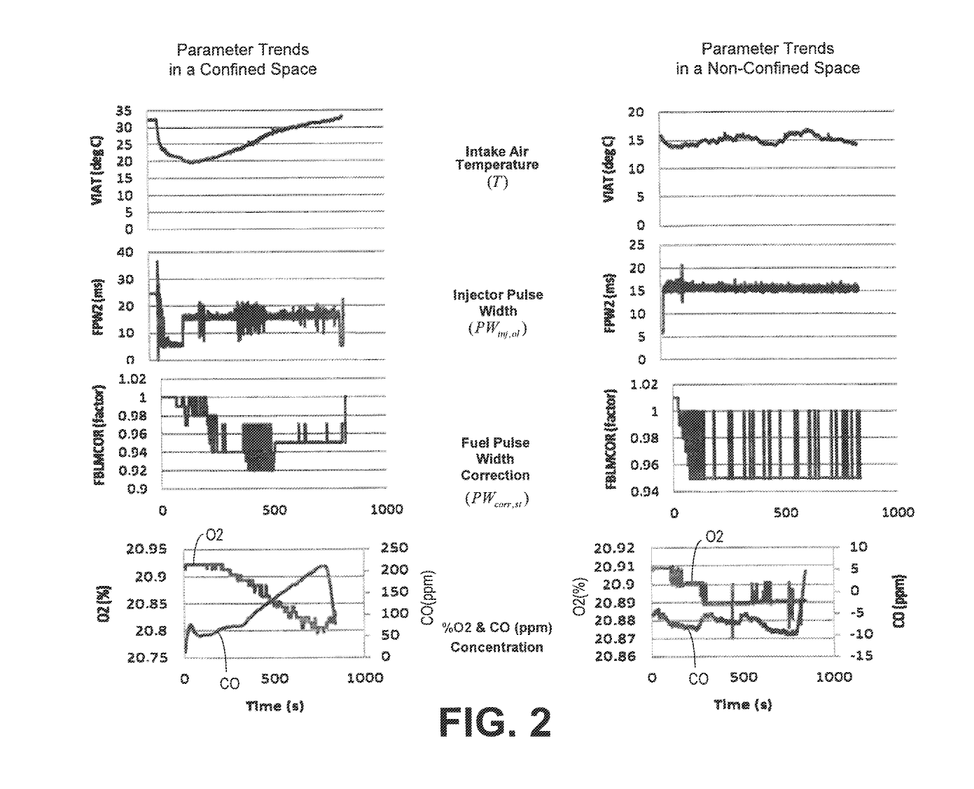

FIG. 2 illustrates a comparison of various parameter trends for an engine operated in a confined space versus an engine operated in a non-confined space. Specifically, the parameters are an intake air temperature T, a base fuel injection pulse width PW_{inj,ol}, a fuel injection pulse width correction factor PW_{corr,st}, O₂ percentage levels, and CO parts per million (ppm). These parameters were measured for 1,000 seconds and plotted versus time.

As can be seen in the parameter trends in a non-confined space in FIG. 2, the temperature and base fuel injection pulse width PW_{inj,ol} are pretty stable during the operation of the engine in a non-confined space, and the fuel injection pulse width correction factor PW_{corr,st} appears to switch back and forth between a value of 1 and 0.95. Also, the O₂ levels also seem to stabilize around 20.89% and the atmospheric CO concentration is fairly low at −10 ppm.

In contrast, the parameter trends in a confined space in FIG. 2 show a temperature that gradually increases as well as a fuel injection pulse width correction factor PW_{corr,st} that decreases to correct the fuel injection pulse width. Also, the O₂ levels as a percentage appear to decrease significantly as compared to the O₂ levels measured when the engine was operated in a non-confined space. Also, the CO levels rise significantly when the engine is operated in a confined space, changing from close to 0 ppm to slightly over 200 ppm.

When an engine is operated in a confined space, the base fuel injection pulse width will increase in response to the throttle opening even though the fuel injection pulse width correction factor is decreasing. Consequently, a base fuel injection pulse width that increases while the fuel injection pulse width correction factor decreases indicates that the engine is being operated in a confined space.

The base fuel injection pulse width increases because, as discussed above, after the engine has been operating in a confined space, the ratio of O₂ to inert gases in the air is such that there is less O₂ than in the air in a non-confined space. Accordingly, the relationship between the engine load indicating parameter, in this case MAP, and the actual engine load and corresponding fuel requirement is altered. Consequently, the base pulse width calculated corresponds to a higher-than-actual load and a correspondingly higher-than-actual amount of oxygen trapped in the combustion chamber. This calculated base pulse width therefore results in a rich mixture causing the oxygen sensor to sense less oxygen in the exhaust, and a corresponding decrease in the pulse-width correction. Another way of viewing this is that because the engine exhaust emitted into the confined space alters the mixture of gases in the air, the calculated fuel injection pulse width becomes distorted because the calculation is based on the faulty assumption that the engine is being operated in air having a certain mixture of oxygen and inert gases.

Some embodiments exploit this faulty assumption by using the calculated base fuel injection pulse width to detect when the engine is operated in a confined space. In some embodiments, the engine is stopped or paused as a safety mechanism responsive to detecting that the engine is operated in a confined space to prevent unsafe levels of CO from being present.

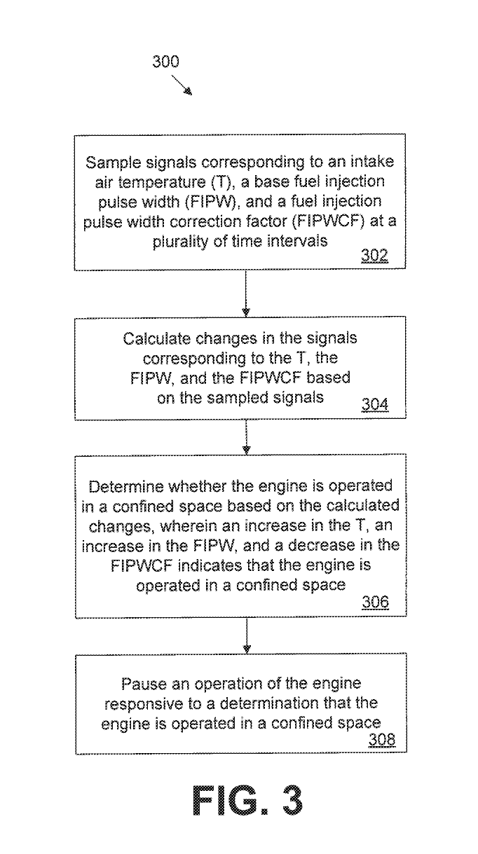

FIG. 3 is a flow chart illustrating an embodiment of a method 300 of detecting that the engine is being operated in a confined space using an engine control module 150 in an engine management system 100. In block 302, signals corresponding to an intake air temperature (T), a base fuel injection pulse width (FIPW), and a fuel injection pulse width correction factor (FIPWCF) are sampled at a plurality of time intervals. In block 304, changes in the signals corresponding to the T, the FIPW, and the FIPWCF based on the samples are calculated. In block 306, whether the engine is operated in a confined space is determined based on the changes calculated in block 304. An increase in the T, an increase in the FIPW, and a decrease in the FIPWCF indicates that the engine is being operated in a confined space. In some embodiments, an increase in the FIPW and a decrease in the FIPWCF alone may indicate that the engine is being operated in a confined space. In block 308, an operation of the engine is paused responsive to a determination that the engine is operated in a confined space.

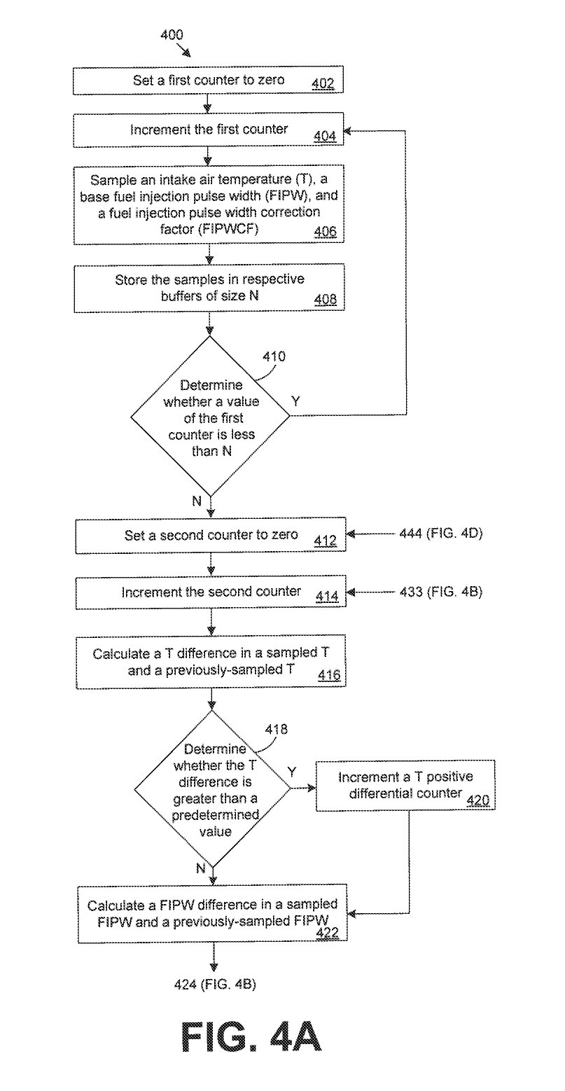

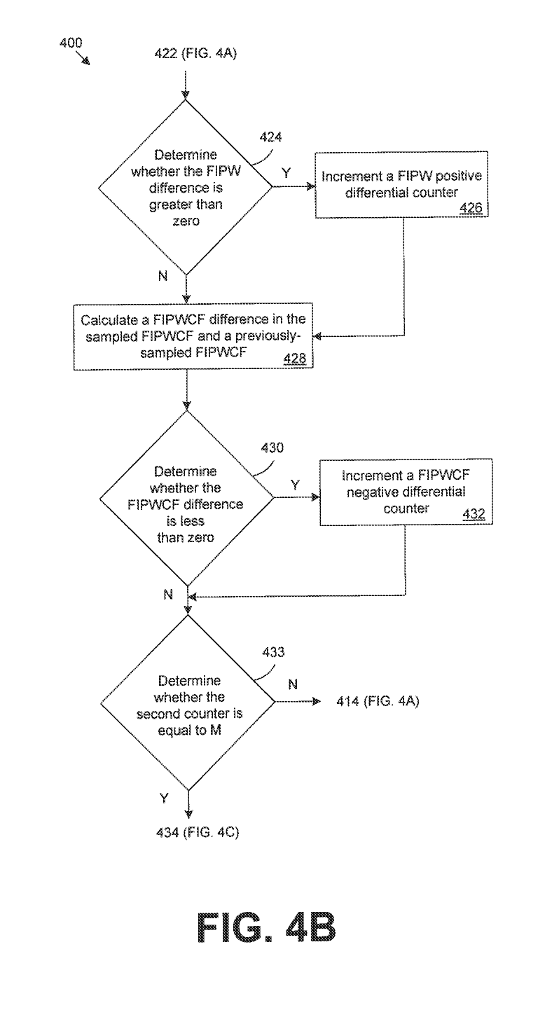

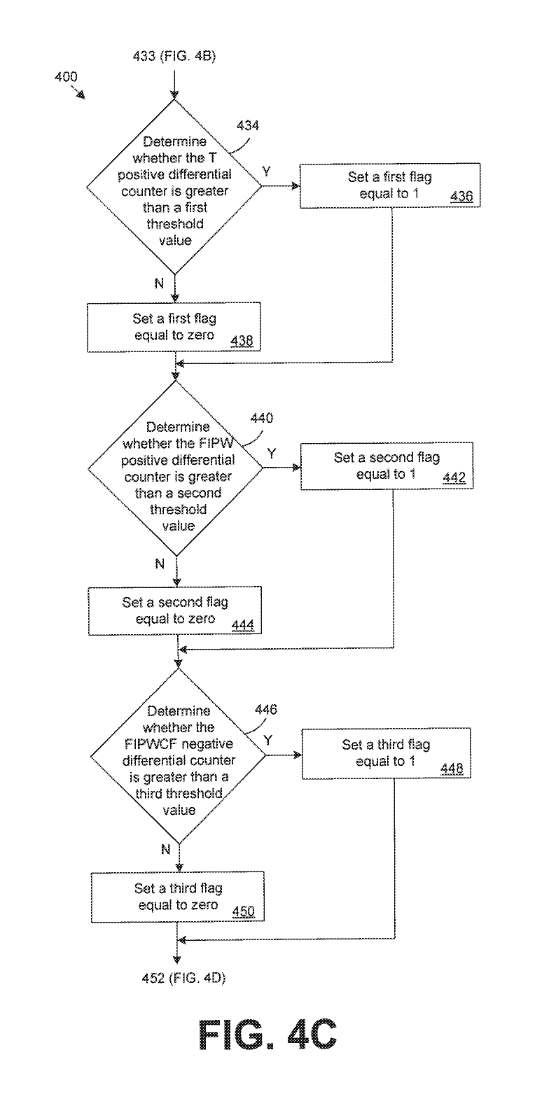

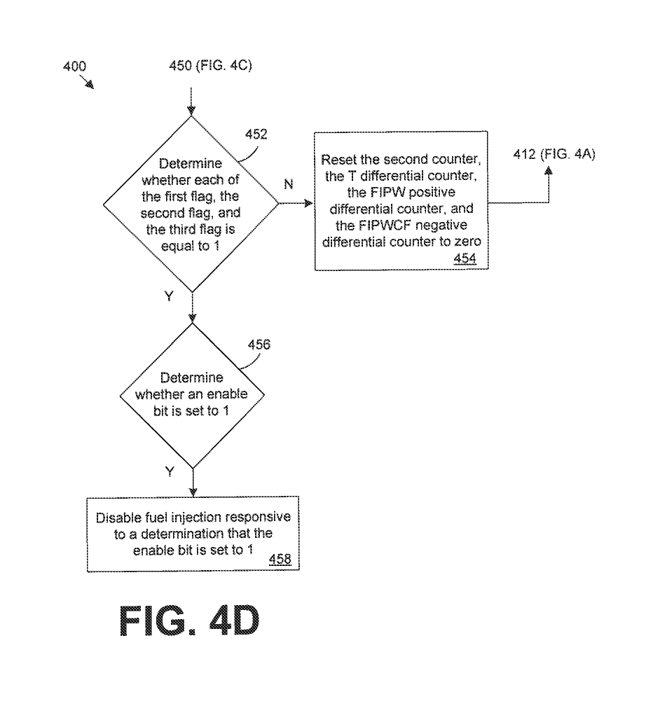

FIGS. 4A, 4B, 4C, and 4D are flow charts illustrating another embodiment of a method 400 of detecting that the engine is being operated in a confined space using an engine control module 150 in an engine management system 100. In block 402, a first counter is set to zero, and the first counter is incremented in block 404. In block 406, an intake air temperature (T), a fuel injection pulse width (FIPW), and a fuel injection pulse width correction factor (FIPWCF) are sampled. In block 408, the samples are stored in respective buffers of size N. In some embodiments, N is equal to 512.

In block 410, whether a value of the first counter is less than N is determined. Responsive to a determination that the value of the first counter is less than N, the method loops back to block 404. Responsive to a determination that the value of the first counter is not less than N, the method 400 proceeds to block 412. In block 412, a second counter is set to zero, and the second counter is incremented in block 414.

In block 416, a T difference in a sampled T and a previously-sampled T is calculated. In other words, in block 416 a change (e.g., a derivative) in the temperature is calculated. In block 418, whether the T difference is greater than a predetermined value is determined. In some embodiments, the predetermined value is 2.048. Responsive to a determination that the T difference is greater than a predetermined value, a T positive differential counter is incremented in block 420, and then a FIPW difference in a sampled FIPW and a previously-sampled FIPW is calculated in block 422. Responsive to a determination that the T difference is not greater than a predetermined value, a FIPW difference in a sampled FIPW and a previously-sampled FIPW is calculated in block 422. In other words, in block 422 a change (e.g., a derivative, a gradient, etc.) in the base fuel injection pulse width is calculated.

The method 400 continues in FIG. 4B, which begins with block 424. In block 424, whether the FIPW difference is greater than zero is determined. Responsive to a determination that the FIPW difference is greater than zero, a FIPW positive differential counter is incremented in block 426, and then a FIPWCF difference in a sampled FIPWCF and a previously-sampled FIPWCF is calculated in block 428. Responsive to a determination that the FIPW difference is not greater than zero, a FIPWCF difference in a sampled FIPWCF and a previously-sampled FIPWCF is calculated in block 428. In other words, in block 428 a change (e.g., a derivative, a gradient, etc) in the fuel injection pulse width correction factor is calculated.

In block 430, whether the FIPWCF difference is less than zero is determined. Responsive to a determination that the FIPWCF difference is less than zero, a FIPWCF negative differential counter is incremented in block 432. Then, in block 433, whether the second counter is equal to M is determined. In some embodiments, M is 128. Responsive to a determination that the second counter is not equal to M, the method 400 loops back to block 414 (FIG. 4A). Responsive to a determination that the second counter is equal to M, the method 400 proceeds to block 434 in FIG. 4C.

In block 434, whether the T positive differential counter is greater than a first threshold value is determined. In some embodiments, the first threshold value is 85. In other implementations, the first threshold may be a predefined percentage of M. Responsive to a determination that the T positive differential counter is greater than a first threshold value, a first flag is set equal to 1 in block 436. Responsive to a determination that the T positive differential counter is not greater than a first threshold value, the first flag is set equal to zero in block 438.

In block 440 of FIG. 4C, whether the FIPW positive differential counter is greater than a second threshold value is determined. In some embodiments, the second threshold value is 85. Responsive to a determination that the FIPW positive differential counter is greater than a second threshold value, a second flag is set equal to 1 in block 442. Responsive to a determination that the FIPW positive differential counter is not greater than a second threshold value, the second flag is set equal to zero in block 444.

After block 444 or block 442, whether the FIPWCF negative differential counter is greater than a third threshold value is determined in block 446. In some embodiments, the third threshold value is 85. Responsive to a determination that the FIPWCF negative differential counter is greater than a third threshold value, a third flag is set equal to 1 in block 448. Responsive to a determination that the FIPWCF negative differential counter is not greater than a third threshold value, the third flag is set equal to zero in block 450.

After block 450 or block 448, the method 400 continues in FIG. 4D with block 452. Whether each of the first flag, the second flag, and the third flag is equal to 1 is determined in block 452. Responsive to a determination that the first flag, the second flag, and the third flag are not each equal to 1, the second counter, the T differential counter, the FIPW positive differential counter, and the FIPWCF negative differential counter are reset to zero in block 454 and the method 400 loops back to block 412 (FIG. 4A). Responsive to a determination that the first flag, the second flag, and the third flag are each equal to 1, whether an enable bit is set to 1 is determined in block 456. In response to the enable bit being set to 1, the fuel injection is disabled in block 458, shutting off the engine. The flags and the enable bit described above are Booleans. So, in other embodiments, the convention may be that the flags are set to zero instead of one and one instead of zero.

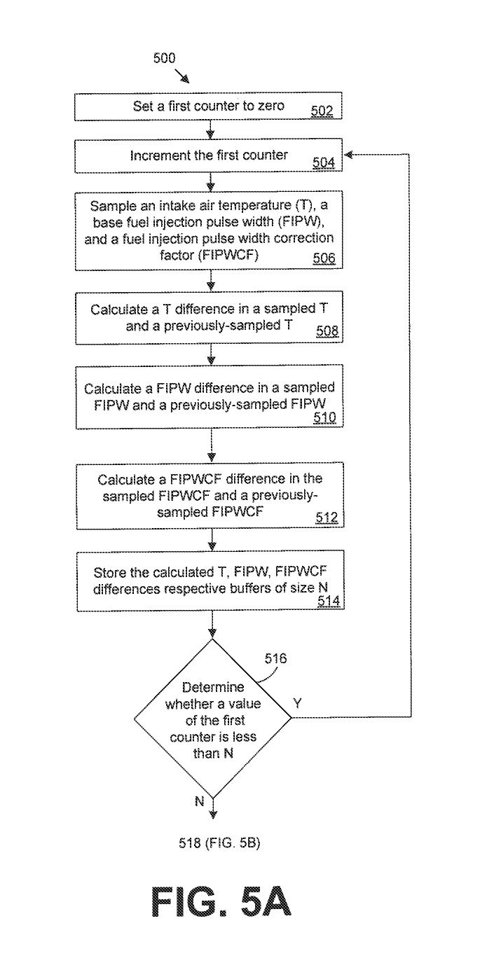

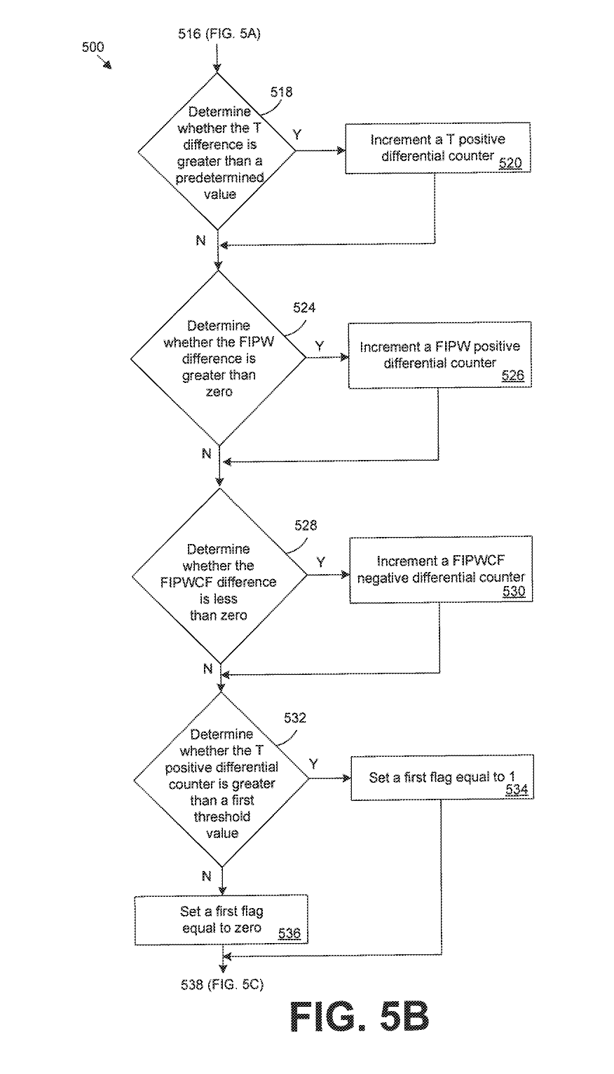

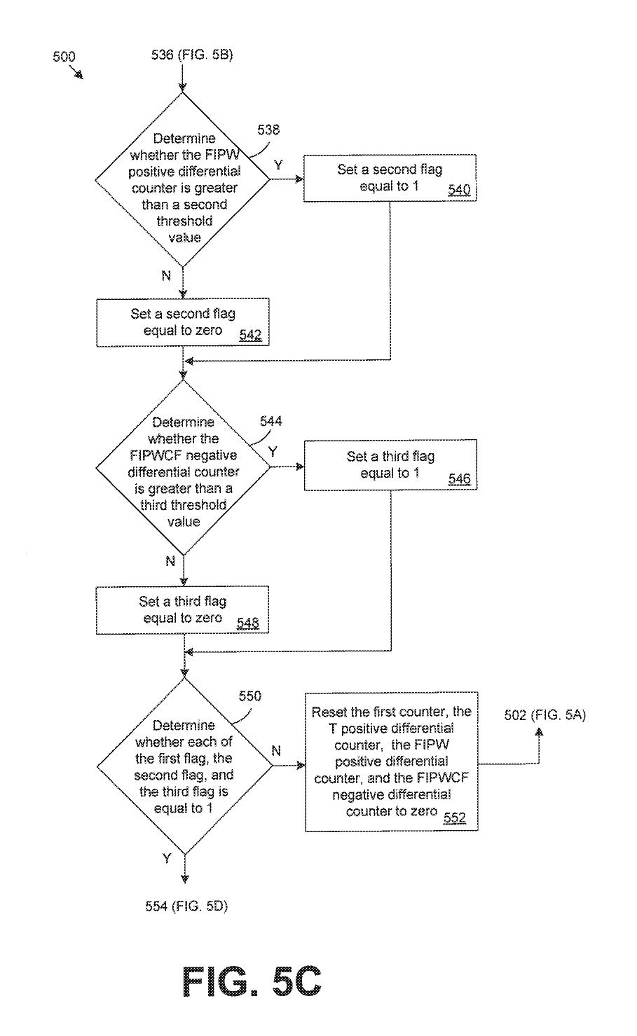

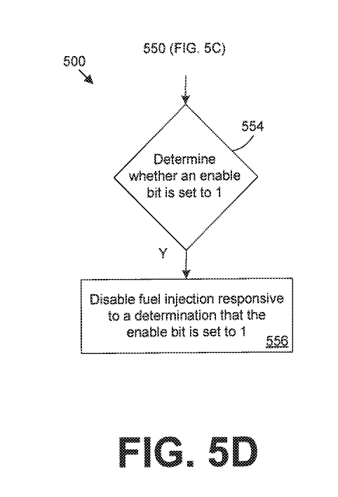

FIGS. 5A-5D are flow charts illustrating a further embodiment of a method 500 of detecting that the engine is being operated in a confined space using an engine control module 150 in an engine management system 100. In block 502, a first counter is set to zero, and the first counter is incremented in block 504. In block 506, an intake air temperature (T), a base fuel injection pulse width (FIPW), and a fuel injection pulse width correction factor (FIPWCF) are sampled. In block 508, a T difference in a sampled T and a previously sampled T is calculated. In the case where T is initially sampled, a previously sampled T is not available. In this case, a T difference may be calculated based upon the initial sampled T and a predefined value of T representing the previously sampled T. Similarly, in block 510, a FIPW difference in a sampled FIPW and a previously sampled FIPW is calculated. Further, a FIPWCF difference in a sampled FIPWCF and a previously sampled FIPWCF is calculated in block 512. In block 514, the calculated T, FIPW, and FIPWCF differences are stored in respective buffers each of size N.

In block 516, whether a value of the first counter is less than N is determined. Responsive to the value of the first counter being determined to be less than N, the method 500 loops back to block 504. Responsive to the value of the first counter being determined to not be less than N, the method 500 proceeds to block 518 of FIG. 5B. In block 518, whether the T difference is greater than a predetermined value is determined. In some embodiments, the predetermined value is 2.048. Responsive to a determination that the T difference is greater than the predetermined value, a T positive differential counter is incremented in block 520.

Then, in block 524, whether the FIPW difference is greater than zero is determined. Responsive to a determination that the FIPW difference is greater than zero, a FIPW positive differential counter is incremented in block 526. Then, in block 528, whether the FIPWCF difference is less than zero is determined. Responsive to a determination that the FIPWCF difference is less than zero, a FIPWCF negative differential counter is incremented in block 530. In block 532, whether the T positive differential counter is greater than a first threshold value is determined. In some embodiments, the first threshold value is 85. Responsive to a determination that the T positive differential counter is greater than the first threshold value, a first flag is set equal to 1 in block 534. Responsive to a determination that the T positive differential counter is not greater than the first threshold value, a first flag is set equal to zero in block 536.

The method 500 continues in FIG. 5C, which begins with block 538. In block 538, whether the FIPW positive differential counter is greater than a second threshold value is determined. In some embodiments, the second threshold value is 85. Responsive to a determination that the FIPW positive differential counter is greater than the second threshold value, a second flag is set equal to 1 in block 540. Responsive to a determination that the FIPW positive differential counter is not greater than the second threshold value, a second flag is set equal to zero in block 542.

In block 544, whether the FIPWCF negative differential counter is greater than a third threshold value is determined. In some embodiments, the third threshold value is 85. Responsive to a determination that the FIPWCF negative differential counter is greater than the third threshold value, a third flag is set equal to 1 in block 546. Responsive to a determination that the FIPWCF negative differential counter is not greater than the third threshold value, a third flag is set equal to zero in block 548.

In block 550, whether each of the first flag, the second flag, and the third flag is equal 1 is determined. Responsive to a determination that each of the first flag, the second flag, and the third flag is not equal 1, the first counter, the T positive differential counter, the FIPW positive differential counter, and the FIPWCF negative differential counter are reset to zero in block 552. After block 552, the method 500 loops back to block 502 in FIG. 5A. Responsive to a determination that each of the first flag, the second flag, and the third flag is equal 1, the method 500 proceeds to block 554 in FIG. 5D. In block 554, whether an enable bit is set to 1 is determined. Responsive to a determination that the enable bit is set, the fuel injection is disabled in block 556, shutting down the engine.

As indicated above, when an engine is running with a fixed load in a confined space, the intake air temperature (T) increases, the fuel injection pulse width (FIPW) increases, and the pulse width correction factor (FIPWCF) decreases. Under operation with a fixed load in the open enclosure, the fuel pulse width and pulse width correction factor do not both change in this manner, nor do any variations in this signal last for as long a period of time as when operating in a fully enclosed environment. Thus, the fuel pulse width and pulse width correction trends are key identifiers of operation with a fixed load in a confined space. In addition, the enclosed environment will trap exhaust gas, which is generally at a temperature greater than the ambient air. Thus, intake air temperature (T) is expected to be increasing in an enclosed environment.

The algorithms described above are based on pseudo-derivatives of moving averages of the T, FIPW, and FIPWCF. As each new sample of these signals is received, the difference between it and a previous value (e.g., many samples earlier) is computed. When all three pseudo-derivatives have been at unacceptable levels for a significant number of samples within a window of a fixed number of samples, the algorithm triggers an engine shutdown by having the ECU send a signal that disables fuel injection. In essence, when the T and FIPW have been steadily increasing and FIPWCF has been steadily decreasing for some period of time, the algorithm concludes that the engine is operating in an enclosed environment and disables fuel injection to the engine, thereby shutting it off.

Testing was performed to confirm the validity of the algorithm and the results were 100% accurate for a specific set of parameters and thresholds. However, the algorithm was found to have limitations in subsequent testing. First, with sudden and significant load changes, as well as under constant load, the algorithm can sometimes cause the engine to shutoff when operated unconfined outdoors. Second, the algorithm many not always cause the engine to shutoff in an enclosed environment with extremely light loads. Third, in rare cases, the algorithm may not shut the engine off when operating in an enclosed environment even with a high load. In view of these findings, an alternative analysis of the real-time data was performed to determine if any of the operating parameters could be used to estimate the oxygen concentration in the intake air, and thus be used as the basis for an advanced shutoff algorithm.

Numerical estimation of O₂ concentration in the intake air is derived from the EMS operating principles presented above. As was explained, the engine control module uses the ideal gas law, as indicated in Eqn. (3), to calculate the manifold density (ρₐᵢᵣ) from manifold absolute pressure (Pₘₐₙ), the intake charge air temperature (T), and R, the gas constant for air. When the intake gas is composed of less air and more CO, the effective gas constant for the intake gas will be different from that of air. Thus, if the gas constant can be estimated from internal controller signals, then the O₂ concentration can be estimated. However, directly estimating the intake gas constant is unlikely to yield the precision necessary to distinguish between values that are only slightly different from the gas constant for air, which is 0.286 kJ/kg-K. For frame of reference, the gas constant for pure CO is 0.297 kJ/kg-K. Therefore, some simplification was applied by looking at the mathematical ratio of the base pulse width, which the controller computes using the gas constant for air, to the actual or final pulse width, which is the actual time the fuel injector is open after adjustment of the base pulse width based on controller feedback that is indicative of engine performance. This ratio of base pulse width to final (actual) pulse width (the “pulse width ratio”) is a measure of how much the controller must compensate for lack of O₂ in the intake gas stream and is defined as an approximate ratio of gas constants in Eqn. (10):

[symbol]

$$\frac{\text{?}}{\text{?}} = \frac{\text{?}}{\text{?}} \\ \text{?} \text{indicates text missing or illegible when filed} \qquad ( 10 )$$

where t_{PWbase} is the base pulse width and t_{PWfinal} is the final pulse width. Applying Eqn. (10) to a number of different data sets, the relationship in Eqn. (11) was heuristically developed to estimate the percentage of O₂ in the intake air.

$$9602 = \frac{\text{?}}{\text{?}} 175 + 18 \\ \text{?} \text{indicates text missing or illegible when filed} \qquad ( 11 )$$

In Eqn. (10), T is the intake charge air temperature in absolute temperature units. The temperate is calculated using a weighted average of the intake air temperature measured by a sensor located in the air filter housing, and the oil temperature measured by a sensor located in the crankcase.

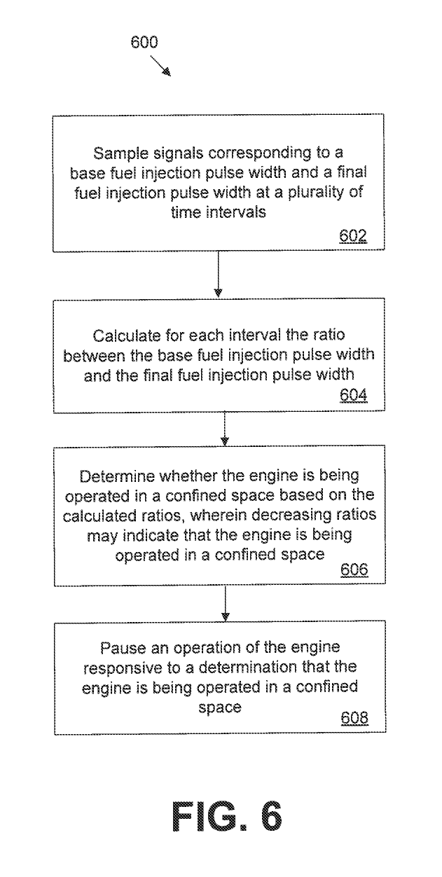

FIG. 6 is a flow chart illustrating an embodiment of a method 600 for detecting that the engine is being operated in a confined based upon the above-described alternative analysis. Beginning with block 602 of FIG. 6A, signals corresponding to the base pulse width (t_{PWbase}) and the final pulse width (t_{PWfinal}) are sampled at a plurality of time intervals. In block 604, the ratio between t_{PWbase} and t_{PWfinal} (i.e., the pulse width ratio) at each interval is calculated. In block 606, it is determined whether the engine is being operated in a confined space based on the calculated pulse width ratios, wherein decreasing pulse width ratios indicate that there is less O₂ in the intake air, which in turn indicates that the engine is being operated in a confined space. Finally, in block 608, an operation of the engine is paused responsive to a determination that the engine is operated in a confined space.

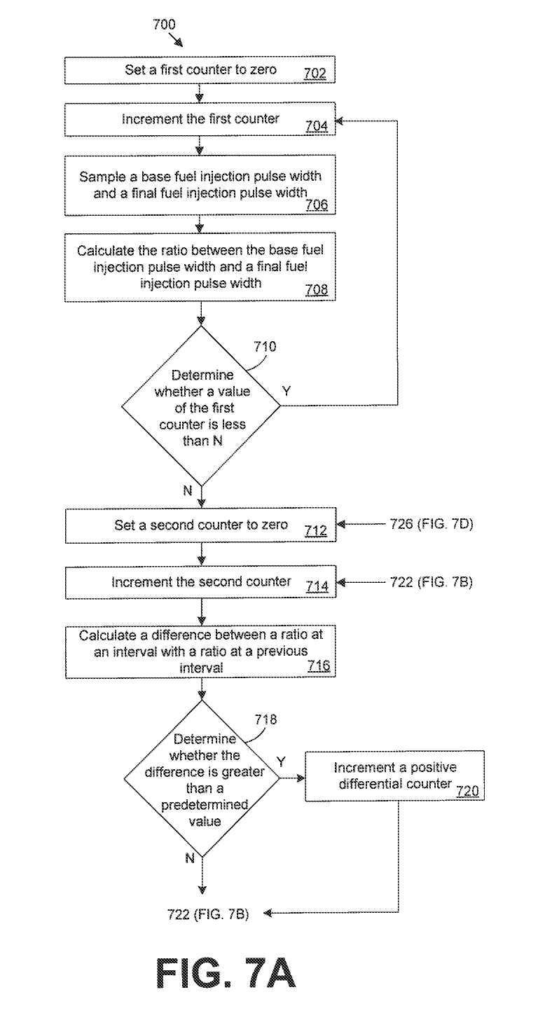

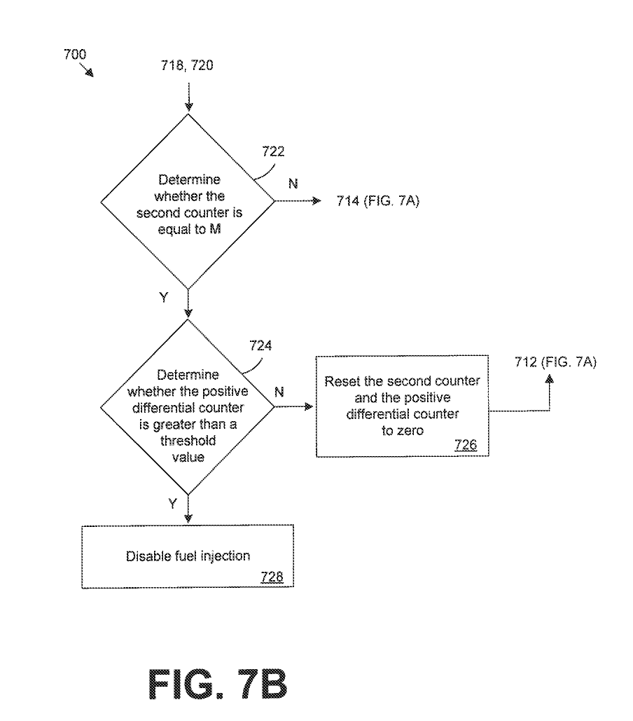

FIGS. 7A and 7B are flow charts illustrating a further embodiment of a method 700 of detecting that the engine is being operated in a confined space. Beginning with block 702 of FIG. 7A, a first counter is set to zero, and the first counter is incremented in block 704. In block 706, a base pulse width (t_{PWbase}) and a final pulse width (t_{PWfinal}) are sampled. In block 708, the pulse width ratio between t_{PWbase} and t_{PWfinal} are calculated.

In block 710, it is determined whether or not a value of the first counter is less than N. In some embodiments, N is 512. Responsive to a determination that the value of the first counter is less than N, the method loops back to block 704. Responsive to a determination that the value of the first counter is not less than N, the method proceeds to block 712. In block 712, a second counter is set to zero, and the second counter is incremented in block 714.

In block 716, a difference between a pulse width ratio at one interval and a pulse width ratio at a previous interval (e.g., many intervals earlier) is calculated. In other words, the change (e.g., a derivative) in the pulse with ratio is calculated. In block 418, it is determined whether or not the difference is greater than a predetermined value. Responsive to a determination that the difference is greater than the predetermined value, a positive differential counter is incremented in block 720.

With reference next to block 722 of FIG. 7B, it is determined whether or not the second counter is equal to M. In some embodiments, M is 128. Responsive to a determination that the second counter is not equal to M, the method loops back to block 714 (FIG. 7A). Responsive to a determination that the second counter is equal to M, the method proceeds to block 724.

In block 724, it is determined whether or not the positive differential counter is greater than a threshold value. Responsive to a determination that the positive differential counter is not greater than the threshold value, the second counter and the differential counter are reset to zero in block 726 and the method loops back to block 712 (FIG. 7A). Responsive to a determination that the positive differential counter is greater than the threshold value, it is assumed that the O₂ levels in the intake air are decreasing and that the engine is therefore being operated in a confined space. In such a case, fuel injection is disabled, as indicated in block 728, and the engine shuts down.

In the methods of FIGS. 6 and 7, engine shutdown is based on a trend of decreasing pulse width ratios, which are indicative of decreasing levels of O₂ in the intake air (which is indicative of a confined space). It is noted, however, that various other criteria could be used in the shutdown determination. For example, shutdown could be based on a consistently decreasing O₂ concentration coupled with a simultaneous increasing trend in MAP. The increasing trend in MAP could be used to distinguish a decreasing O₂ estimate due strictly to load changes from high to low, in which case MAP is decreasing. Under normal operation, MAP increases as load increases and also, as observed in the enclosure testing, for a given load, MAP increases as O₂ levels drop. Refinement of the relationship so the estimated O₂ more closely matches the measured O₂ may prove successful since the derivatives of the measured O₂ data appear sufficient to distinguish between tests in which oxygen depletion was and was not occurring. If a more precise relationship can be identified, consideration can be given to the fact that even when the engine is operating in an enclosed environment, the O₂ level may initially deplete but could eventually reach equilibrium. Another possibility for shutoff criteria is focusing on the actual O₂ estimate and the integral of the O₂ estimate. This enables the assessment of O₂ concentration in terms of how far below some nominal value the O₂ level may be, as well as how long it has been below the nominal value.

The flow charts of this disclosure show the architecture, functionality, and operation of a possible implementation of the engine control module 150 of the engine management system 100 of FIG. 1. The functionality of various blocks in the flow charts may be embodied in software stored on a computer readable medium, code executed by general purpose hardware, dedicated hardware, or a combination of software/general purpose hardware and dedicated hardware.

If embodied in software, each block of the flow charts may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. The computer readable medium can be, for example, but not limited to, an electronic, magnetic, optical, electromagnetic, infrared, or semiconductor system, apparatus, or device.

If embodied in dedicated hardware, the functionality of these components can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, programmable gate arrays (PGA), field programmable gate arrays (FPGA), or other components, etc. Such technologies are generally appreciated by those skilled in the art and, consequently, are not described in detail herein.

Further, each block in the flow charts represents a module, segment, or portion of code, which comprises one or more executable instructions for implementing the specified logical function(s). It should also be noted that in some alternative implementations, the functions noted in the blocks may occur out of the order noted in the flow charts. For example, two blocks shown in succession in the flow charts may in fact be executed substantially concurrently or the blocks may sometimes be executed in the reverse order, depending upon the functionality involved.

It should be emphasized that the above-described embodiments are merely possible examples of implementations set forth for a clear understanding of the principles of the disclosure. Many variations and modifications may be made to the above-described embodiments without departing substantially from the spirit and principles of the disclosure. All such modifications and variations are intended to be included herein within the scope of this disclosure and the present application.

We claim:

1. A method performed by an engine management system for detecting that an engine is being operated in a confined space, the method comprising:
sampling signals corresponding to multiple engine operating parameters;
monitoring changes in the parameters; and
determining whether or not the engine is being operated in a confined space based upon the monitored changes.

2. The method of claim 1, wherein sampling signals comprises sampling signals corresponding to a base fuel injection pulse width and a fuel injection pulse width correction factor at a plurality of intervals.

3. The method of claim 2, wherein monitoring changes in the parameters comprises subtracting a sample of a signal by a previously-sampled sample of a signal.

4. The method of claim 2, wherein determining whether or not the engine is being operated in a confined space comprises determining that the engine is being operated in a confined space if the base fuel injection pulse width increases and the fuel injection pulse width correction factor decreases over time.

5. The method of claim 2, wherein sampling signals further comprises sampling an intake air temperature and determining that the engine is being operated in a confined space if the base fuel injection pulse width increases, the fuel injection pulse width correction factor decreases, and the intake air temperature increases over time.

6. The method of claim 2, wherein the base fuel injection pulse width is calculated based at least in part on a stoichiometric mixture of fuel and air.

7. The method of claim 2, wherein the fuel injection pulse width correction factor is calculated based at least in part on feedback related to the base fuel injection pulse width.

8. The method of claim 1, wherein sampling signals comprises sampling signals corresponding to a base fuel injection pulse width and an actual fuel injection pulse width at a plurality of intervals.

9. The method of claim 8, wherein monitoring changes in the base fuel injection pulse width and the actual fuel injection pulse width comprises subtracting a sample of a signal by a previously-sampled sample of a signal.

10. The method of claim 8, wherein determining whether or not the engine is being operated in a confined space comprises calculating the mathematical ratio of the base fuel injection pulse width and the actual fuel injection pulse width at multiple intervals by dividing the base fuel injection pulse width by the actual fuel injection pulse width, determining if the ratio is decreasing over time, and, if the ratio is decreasing over time, determining that the engine is being operated in a confined space.

11. The method of claim 8, wherein the base fuel injection pulse width is calculated based at least in part on a stoichiometric mixture of fuel and air.

12. The method of claim 8, wherein the actual fuel injection pulse width is calculated based at least in part on feedback related to the base fuel injection pulse width.

13. The method of claim 1, further comprising automatically shutting down the engine if it is determined that the engine is being operated in a confined space.

14. An engine management system configured to detect that an engine is being operated in a confined space, the system comprising:
an engine control module configured to monitor changes in engine operating parameters and to determine whether or not the engine is being operated in a confined space based upon the monitored changes.

15. The system of claim 14, wherein the engine control module is configured to monitor changes in a base injection pulse width and a fuel injection pulse width correction factor at a plurality of intervals.

16. The system of claim 15, wherein the engine control module is configured to monitor changes in the base injection pulse width and the fuel injection pulse width correction factor subtracting a sample of a signal by a previously-sampled sample of a signal.

17. The system of claim 15, wherein the engine control module is configured to determine that the engine is being operated in a confined space if the base fuel injection pulse width increases and the fuel injection pulse width correction factor decreases over time.

18. The system of claim 15, further comprising a sensor for sampling intake air temperature and wherein the engine control module is configured to determine that the engine is being operated in a confined space if the base fuel injection pulse width increases, the fuel injection pulse width correction factor decreases, and the intake air temperature increases over time.

19. The system of claim 15, wherein the engine control module is configured to calculate the base fuel injection pulse width based at least in part on a stoichiometric mixture of fuel and air.

20. The system of claim 15, wherein the engine control module is configured to calculate the fuel injection pulse width correction factor based at least in part on feedback related to the base fuel injection pulse width.

21. The system of claim 14, wherein the engine control module is configured to monitor changes in a base fuel injection pulse width and an actual fuel injection pulse width.

22. The system of claim 21, wherein the engine control module is configured to monitor changes in the base injection pulse width and the actual fuel injection pulse width by subtracting a sample of a signal by a previously-sampled sample of a signal.

23. The system of claim 21, wherein the engine control module is configured to calculate the mathematical ratio of the base fuel injection pulse width and the actual fuel injection pulse width at multiple intervals by dividing the base fuel injection pulse width by the actual fuel injection pulse width, determining if the ratio is decreasing over time, and, if the ratio is decreasing over time, determining that the engine is being operated in a confined space.

24. The system of claim 21, wherein the engine control module is configured to calculate the base fuel injection pulse width based at least in part on a stoichiometric mixture of fuel and air.

25. The system of claim 21, wherein the engine control module is configured to calculate the actual fuel injection pulse width based at least in part on feedback related to the base fuel injection pulse width.

26. The system of claim 14, wherein the engine control module is configured to automatically shut down the engine if it determines that the engine is being operated in a confined space.
